(19) United States
(12) Patent Application Publication
(10) Pub. No.: US 2007/0165171 A1
(43) Pub. Date: Jul. 19, 2007

(54) Liquid crystal display device and driving method thereof

(76) Inventor: Yun-Bok Lee, Seoul (KR)

Correspondence Address: MCKENNA LONG & ALDRIDGE LLP, 1900 K STREET, NW, WASHINGTON, DC, 20006, US

(21) Appl. No.: 11/017,219

(22) Filed: Dec. 21, 2004

(30) Foreign Application Priority Data
Dec. 29, 2003 (KR) 10-2003-0098685

(51) Int. Cl. G02F 1/1343

(52) U.S. Cl. 349/139; 349/141

(57) ABSTRACT

A liquid crystal display device includes first and second gate lines in an active region, and first and second data lines crossing the first and second gate lines, respectively, wherein the first and second gate lines, and the first and second data lines define first and second pixel regions, first and second thin film transistors in the first and second pixel regions, wherein the first thin film transistors connected with the first data line and the second gate line, and the second thin film transistor connected with the second data line and the first gate line, first and second pixel electrodes connected with the first and second thin film transistors, first and second common electrodes defining first and second substantially circular band shaped regions with the first and second pixel electrodes, and a first common line connected with the first and second common electrodes.

This application claims the benefit of Korean Patent Application No. 2003-0098685, filed on Dec. 29, 2003, which is hereby incorporated by reference for all purposes as if fully set forth herein.

### BACKGROUND OF THE INVENTION

1. Field of the Invention

The present invention relates to a liquid crystal display (LCD) device and a fabricating method thereof.

2. Discussion of the Related Art

A liquid crystal display (LCD) device uses the optical anisotropy and polarization properties of liquid crystal molecules to produce an image. Liquid crystal molecules have a definite orientation and alignment based on their long, thin shapes. That alignment direction can be controlled by an applied electric field. In other words, as an applied electric field changes, so does the alignment of the liquid crystal molecules. Due to the optical anisotropy, the refraction of incident light depends on the alignment direction of the liquid crystal molecules. Thus, by properly controlling an applied electric field, a desired light image can be produced.

Of the different types of known liquid crystal displays (LCDs), active matrix LCDs (AM-LCDs), which have thin film transistors (TFTs) and pixel electrodes arranged in a matrix form, are the subject of significant research and development because of their high resolution and superiority in displaying moving images.

LCD devices have wide application in office automation (OA) equipment and video units because they are light, thin and have low power consumption characteristics. The liquid crystal display panel has an upper substrate, a lower substrate and a liquid crystal layer interposed therebetween. The upper substrate, commonly referred to as a color filter substrate, usually includes a common electrode and color filters. The lower substrate, commonly referred to as an array substrate, includes switching elements, such as thin film transistors and pixel electrodes.

As previously described, LCD device operation is based on the principle that the alignment direction of the liquid crystal molecules is dependent upon an electric field applied between the common electrode and the pixel electrode. Thus, the alignment direction of the liquid crystal molecules is controlled by the application of an electric field to the liquid crystal layer. When the alignment direction of the liquid crystal molecules is properly adjusted, incident light is refracted along the alignment direction to display images. The liquid crystal molecules function as an optical modulation element having variable optical characteristics that depend upon polarity of the applied voltage.

In an LCD device, because the pixel and common electrodes are positioned on the lower and upper substrates, respectively, the electric field induced between them is perpendicular to the lower and upper substrates. However, the LCD devices having the longitudinal electric field have a disadvantage in that they have a very narrow viewing angle. In order to solve the problem of narrow viewing angle, in-plane switching liquid crystal display (IPS-LCD) devices have been developed. The IPS-LCD devices include a lower substrate where a pixel electrode and a common electrode are disposed, an upper substrate having no electrode, and a liquid crystal interposed between the upper and lower substrates. A detailed explanation about operation modes of an IPS-LCD panel will be provided with reference to FIG. 1.

FIG. 1 is a schematic cross-sectional view for a concept of an IPS-LCD according to the related art.

As illustrated in FIG. 1, upper and lower substrates 10 and 20 are spaced apart from each other, and a liquid crystal layer 30 is interposed therebetween. The upper and lower substrates 10 and 20 are often referred to as an array substrate and a color filter substrate, respectively. On the lower substrate 20 are a common electrode 22 and a pixel electrode 24. The common and pixel electrodes 22 and 24 are aligned parallel to each other. On a surface of the upper substrate 10, a color filter layer (not illustrated) is positioned between the pixel electrode 24 and the common electrode 22 of the lower substrate 20. A voltage applied across the common and pixel electrodes 22 and 24 produces an electric field 26 through the liquid crystal 32. The liquid crystal 32 has a positive dielectric anisotropy, and thus it aligns parallel to the electric field 26.

Now the description will illustrate the operation of a related art IPS-LCD device. When no electric field is produced by the common and pixel electrodes 22 and 24, i.e., off-state, the longitudinal axes of the liquid crystal (LC) molecules 32 are parallel and form a definite angle with the common and pixel electrodes 22 and 24. For example, the longitudinal axes of the LC molecules 32 are arranged parallel to both the common and pixel electrodes 22 and 24.

On the contrary, when a voltage is applied to the common and pixel electrodes 22 and 24, i.e., on-state, an in-plane electric field 26 that is parallel to the surface of the lower substrate 20 is produced because the common and pixel electrodes 22 and 24 are on the lower substrate 20. Accordingly, the LC molecules 32 are re-arranged to bring their longitudinal axes into coincidence with the electric field 26.

Therefore, the result is a wide viewing angle that ranges from about 80 to 85 degrees in up-and-down (vertical) and left-and-right (horizontal) directions from a line vertical to the IPS-LCD device, for example.

FIG. 2A is a plan view illustrating an IPS-LCD device according to the related art.

As illustrated in FIG. 2A, a data line DL is disposed substantially perpendicular to a gate line GL. A common line CL is also arranged parallel with the gate line GL and is spaced apart from the gate line GL. The gate line GL, the common line CL and the data line DL define a pixel region P. A thin film transistor T is disposed at a cross of the gate and data lines GL and DL. In the pixel region P, both common and pixel electrodes 40 and 42 are arranged alternately and extend along the data line DL.

The IPS-LCD device of FIG. 2A operates the liquid crystal molecules using the in-plane electric field induced between the common and pixel electrodes 40 and 42. Thus, it can provide a wider viewing angle as compared to the LCD device that forms the electric field perpendicular to the array substrate. Some additional modifications to the IPS-LCD device have been developed in order to increase further the viewing angle.

FIG. 2B is a plan view illustrating an IPS-LCD device having multiple domains according to the related art. With reference to FIG. 2B, some of detailed explanations previously explained with reference to FIG. 2A, will be omitted.

As illustrated in FIG. 2B, both the common and pixel electrodes 50 and 52 have zigzag shapes with a plurality of bent portions, but they are parallel to each other and arranged alternately.

The zigzag-shaped common and pixel electrodes 50 and 52 define multidomains in the pixel region symmetrically to the bent portions of the common and pixel electrodes 50 and 52. These zigzag shapes and multidomains provide an improved viewing angle over the straight shape of FIG. 2A.

However, in the IPS-LCD device of FIG. 2B, because alignment directions of liquid crystal molecules are different with respect to the viewing angles, color shifting occurs, and thus the viewing angle is reduced.

FIG. 3 is a graph of viewing angle properties of the IPS-LCD device of FIG. 2B.

As illustrated in FIG. 3, the IPS-LCD device has improved viewing angles in the ±90 and ±180 degree directions, i.e., in right-and-left and up-and-down directions, as illustrated by references IVa and IVb in FIG. 3. However, the image degrades at viewing angles in the ±45 and ±135 degree directions, i.e., in diagonal directions, as illustrated by references IVc and IVd in FIG. 4. Furthermore, the color shift noted above also occurs depending on the viewing angles in all directions.

When the voltages applied to the electrodes generate the electric fields between the common and pixel electrodes, the liquid crystal molecules rotate about 45 degrees in accordance with the electric fields. This causes gray inversion due to the rotation of the liquid crystal molecules. In particular, when the IPS-LCD is operated in gray mode, the IPS-LCD produces yellowish color shift in 45(+45)-degree declination with respect to the liquid crystal polarization because of the optical anisotropy properties of liquid crystal molecules. And the IPS-LCD also produces bluish color shift in 135(−45)-degrees declination with respect to the liquid crystal polarization because of the optical anisotropy properties of the liquid crystal molecules.

FIG. 4 is an equivalent circuit of an IPS-LCD device according to the related art. With reference to FIG. 4, the IPS-LCD has a storage-on-common structure, and all common lines are connected together outside.

As illustrated in FIG. 4, a plurality of pixels P are arranged in a matrix pattern, a plurality of gate lines G1 to Gn, and a plurality of data lines D1 and Dm are connected with the plurality of pixels P. Each pixel P includes a thin film transistor T connected with the gate and data lines, and a liquid crystal capacitor Clc and a storage capacitor Cst connected with the thin film transistor T. The liquid crystal capacitor Clc and the storage capacitor Cst in each of the plurality of pixels P are connected with each of a plurality of common lines Vcom1 to VcomN. A liquid crystal voltage applied to the liquid crystal capacitor Clc operates a liquid crystal. The storage capacitor Cst prevents the liquid crystal voltage applied to the liquid crystal capacitor Clc from falling.

When a constant electric field is applied to a liquid crystal, the liquid crystal deteriorates and image sticking occurs due to the direct current (DC) voltage component. Accordingly, to prevent deterioration of the liquid crystal and to remove the direct current (DC) voltage component, an inversion driving method has been used, in which positive and negative polar data voltages with respect to a common voltage are alternately applied. In particular, of the inversion driving methods available, a dot-inversion driving method, in which a level between the data voltages applied to adjacent pixels is inverted and a level between the data voltages applied to each pixel is inverted per frame, has been used most often. Because the dot-inversion driving method prevents image strains such as flicker and cross-talk, it widely used.

FIG. 5 illustrates waveforms of driving voltages in a dot-inversion method for an IPS-LCD device according to the related art.

As illustrated in FIG. 5, the common voltage V_{COM} has a constant direct current (DC) voltage (i.e., a constant level). Gate voltages V_{G1} to V_{G3} are applied sequentially to gate lines. A level of data voltage V_{DATA} is inverted between adjacent pixels and between adjacent frames.

When the gate voltage V_{G} is in an on-state, i.e., high level, a thin film transistor (T in FIG. 4) turns on, and thus the data voltage V_{DATA} is applied to a liquid crystal capacitor (Clc in FIG. 4) to produce a pixel voltage Vp.

When the gate voltage V_{G} is off-state, i.e., low level, a thin film transistor turns off, and thus the data voltage V_{DATA} is not applied to a liquid crystal capacitor (Clc in FIG. 4). Because the gate electrode and the drain electrode of the thin film transistor (T in FIG. 4) overlap each other, the parasitic capacitance therebetween occurs. Accordingly, the pixel voltage Vp falls by ΔVp when the thin film transistor (T in FIG. 4) turns off.

A liquid crystal voltage Vcel of the liquid crystal capacitor (Clc in FIG. 4) operates a liquid crystal, and that is obtained from subtracting Vcom from Vp. Accordingly, to operate the liquid crystal, the data voltage V_{DATA} has a higher or lower level than the common voltage V_{COM}. When the maximum output voltage of integrated circuit (IC) is 10V, and the common voltage V_{COM} is a direct current (DC) voltage of 5V, the liquid crystal voltage Vcel has a maximum voltage of 5V. Because the common voltage V_{COM} is a direct current (DC) voltage, the swing width of the data voltage V_{DATA} is great. Therefore, the power consumption of the related art IPS-LCD device increases, and integrated circuits (ICs) to output the required high power are needed.

In the related art IPS-LCD, a region between the pixel and common electrodes is an aperture region. Accordingly, to increase the aperture region, a distance between the pixel and common electrodes needs to increase. However, as the distance between the pixel and common electrodes increases, the data voltage increases. Therefore, the power consumption of the related art IPS-LCD increases.

### SUMMARY OF THE INVENTION

Accordingly, the present invention is directed to a liquid crystal display device and a driving method thereof that substantially obviate one or more of the problems due to limitations and disadvantages of the related art.

An advantage of the present invention is to provide a liquid crystal display device and a driving method thereof, which can reduce power consumption and increase viewing angle and aperture ratio.

Additional features and advantages of the invention will be set forth in the description which follows and in part will be apparent from the description, or may be learned by practice of the invention. These and other advantages of the invention will be realized and attained by the structure particularly pointed out in the written description and claims hereof as well as the appended drawings.

To achieve these and other advantages, exemplary embodiments in accordance with the principles of the present invention provides a liquid crystal display device including first and second gate lines in an active region, and first and second data lines crossing the first and second gate lines, respectively, wherein the first and second gate lines, and the first and second data lines define first and second pixel regions, first and second thin film transistors in the first and second pixel regions, wherein the first thin film transistor connected with the first data line and the second gate line, and the second thin film transistor connected with the second data line and the first gate line, first and second pixel electrodes connected with the first and second thin film transistors, first and second common electrodes defining first and second substantially circular band shaped or ring shaped regions with the first and second pixel electrodes, respectively, and a first common line connected with the first and second common electrodes.

In another aspect, a liquid crystal display device includes first and second gate lines in an active region, and first and second data lines crossing the first and second gate lines, respectively, a first pixel connected with the first data line and the second gate line, and a second pixel connected with the second data line and the first gate line, a first thin film transistor and a first liquid crystal capacitor in the first pixel, and a second thin film transistor and a second liquid crystal capacitor in the second pixel, wherein the first and second liquid crystal capacitors are connected with the first and second thin film transistors, respectively, and a first common line connected with the first and second liquid crystal capacitors.

In yet another aspect, a driving method of a liquid crystal display device includes scanning first, second and third gate lines sequentially, applying first and second data voltages to first and second data lines, applying a first common voltage to a first pixel connected with the second gate line and the first data line, and to a second pixel connected with the first gate line and the second data line, wherein the first common voltage have high and low levels alternately per frame, and applying a second common voltage to a third pixel connected with the third gate line and the first data line, and to a fourth pixel connected with the second gate line and the second data line, wherein the second common voltage have high and low levels alternately per frame, wherein the first data voltage applied to the first pixel has a inverse level to the first common voltage, the second data voltage applied to the second pixel has a inverse level to the first common voltage, the first data voltage applied to the third pixel has a inverse level to the second common voltage, and the second data voltage applied to the fourth pixel has a inverse level to the second common voltage.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the present invention and together with the description serve to explain the principles of that invention.

In the drawings:

FIG. 1 is a schematic cross-sectional view illustrating a concept of an IPS-LCD according to the related art;

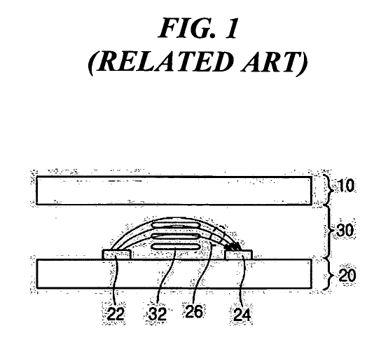

FIG. 2A is a plan view of an IPS-LCD device according to the related art;

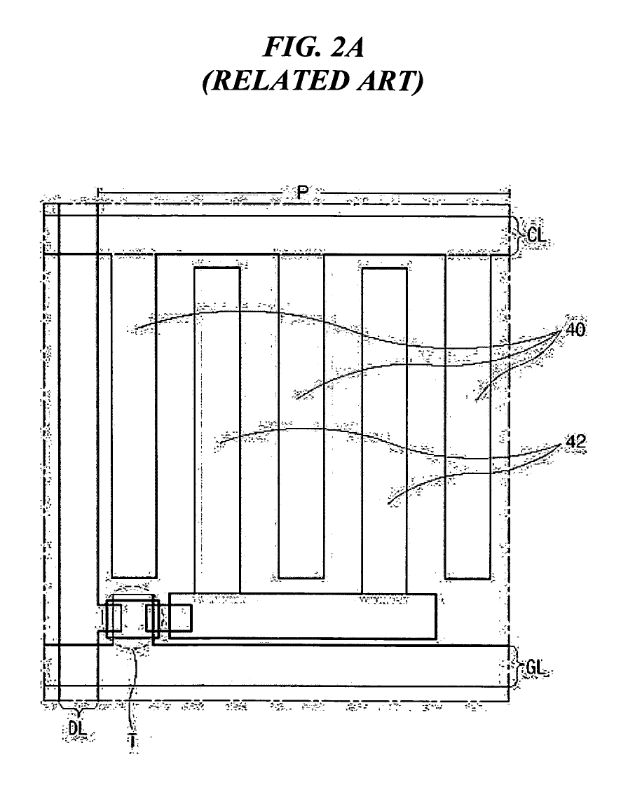

FIG. 2B is a plan view of an IPS-LCD device having multiple domains according to the related art;

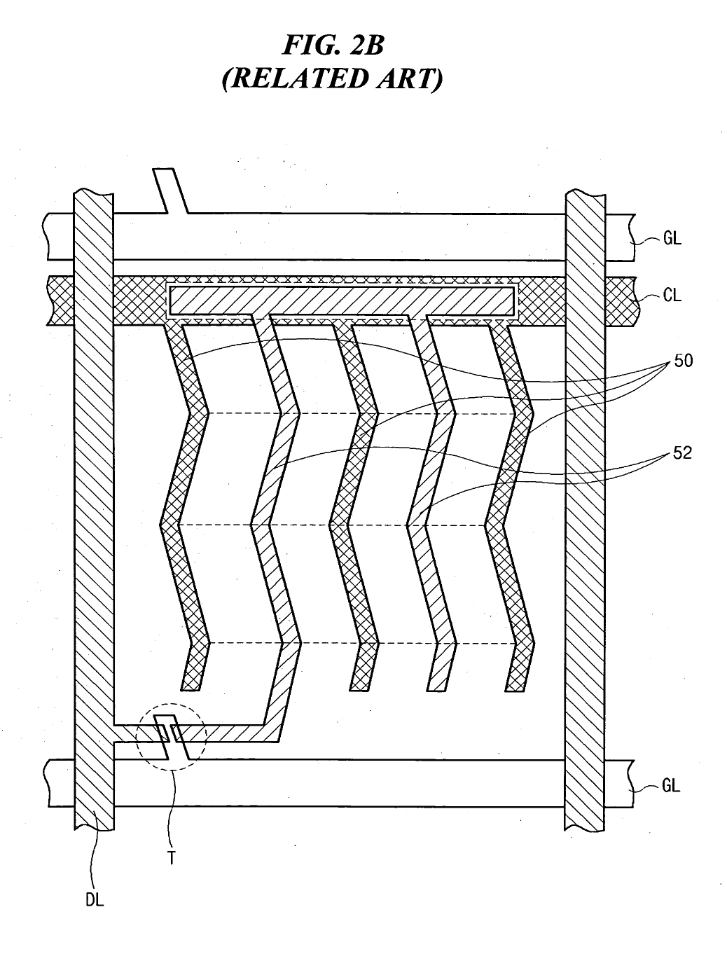

FIG. 3 is a graph of viewing-angle properties of the IPS-LCD device of FIG. 2B;

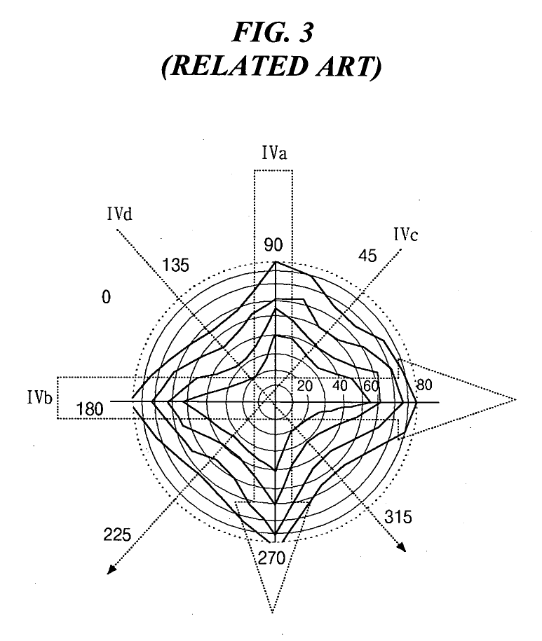

FIG. 4 is an equivalent circuit view of an IPS-LCD device according to the related art;

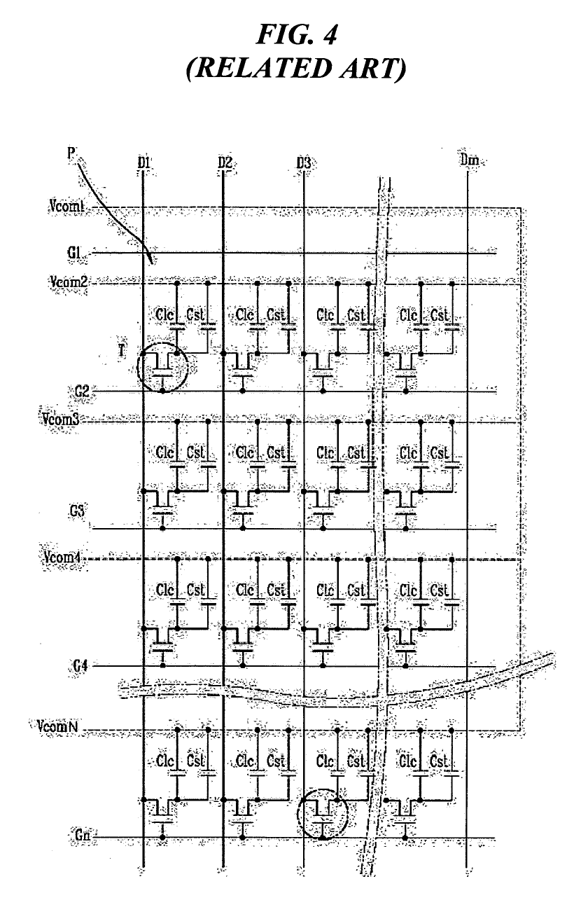

FIG. 5 is a waveform view of driving voltages of a dot-inversion method for an IPS-LCD device according to the related art;

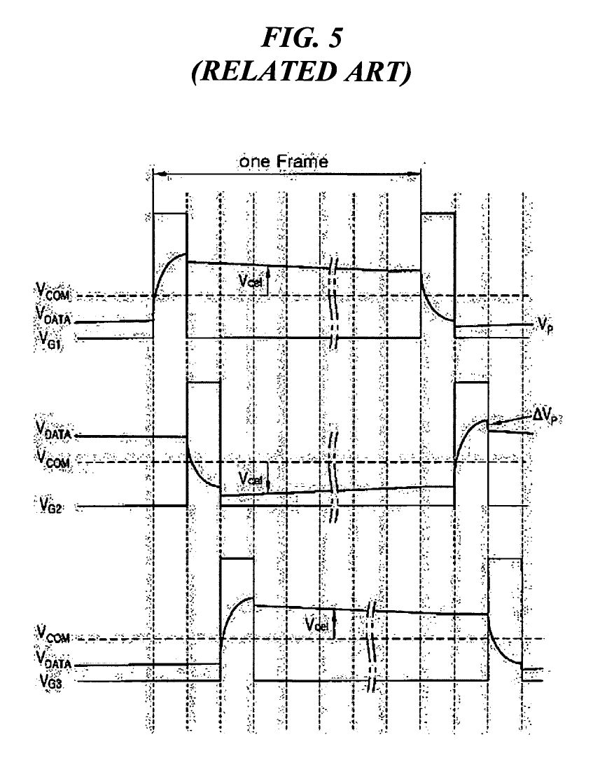

FIG. 6 is a plan view of an in-plane switching mode liquid crystal display (IPS-LCD) device according to a first embodiment of the present invention;

FIG. 7 is an equivalent circuit of an IPS-LCD device according to a second embodiment of the present invention;

FIG. 8 is a waveform view of driving voltages of a line-inversion method for an IPS-LCD device according to the second embodiment of the present invention; and

FIG. 9 is a waveform view of pixel voltages and common voltages applied to adjacent pixels, which are on the same column line, of an IPS-LCD device according to the second embodiment of the present invention.

### DETAILED DESCRIPTION OF THE ILLUSTRATED EMBODIMENTS

Reference will now be made in detail to illustrated exemplary embodiments of the present invention, examples of which are illustrated in the accompanying drawings. Wherever possible, similar reference numbers will be used throughout the drawings to refer to the same or similar parts.

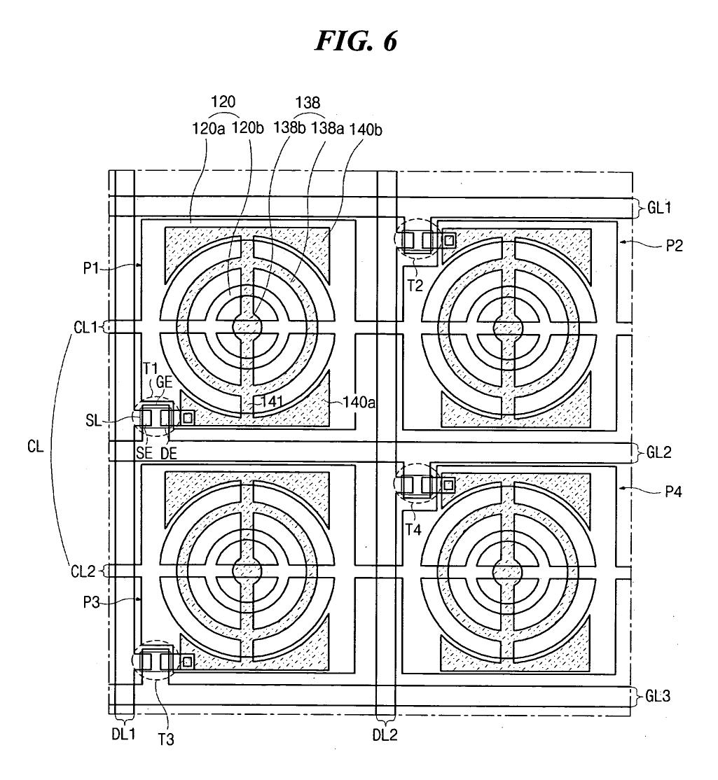

FIG. 6 is a plan view of an in-plane switching mode liquid crystal display (IPS-LCD) device according to a first embodiment of the present invention.

As illustrated in FIG. 6, an IPS-LCD device includes first, second and third gate lines GL1, GL2 and GL3, first and second data lines DL1 and DL2 crossing the gate lines GL1, GL2 and GL3, and first and second common lines CL1 and CL2 parallel to the gate lines GL1, GL2 and GL3 and between adjacent gate lines GL1, GL2 and GL3.

The first and second data lines DL1 and DL2, and the first, second and third gate lines GL1, GL2 and GL3 define first, second, third and fourth pixel regions P1, P2, P3 and P4. The first and second pixel regions P1 and P2 are disposed at both sides of the second data line DL2, the third and fourth pixel regions P3 and P4 are disposed at both sides of the second data line DL2.

In the first, second, third and fourth pixel regions P1, P2, P3 and P4 are disposed first, second, third and fourth thin film transistor T1, T2, T3 and T4 at crosses of the data lines DL1 and DL2, and the gate lines GL1, GL2 and GL3. The first thin film transistor T1 is connected with the second gate line GL2 and the first data line DL1, the second thin film transistor T2 is connected with the first gate line GL1 and the second data line DL2, the third thin film transistor T3 is connected with the third gate line GL3 and the first data line DL1, and the fourth thin film transistor T4 is connected with the second gate line GL2 and the second data line DL2.

Each of the first to fourth thin film transistor T1 to T4 includes a gate electrode GE, a semiconductor pattern SL, a source electrode SE and a drain electrode DE. The gate electrode GE is extended from each of the gate lines GL1 to GL3, the source electrode SE is extended from each of the data lines DL1 and DL2, and the drain electrode DE is apart from the source electrode SE.

The first and second common lines CL1 and CL2 are applied with, respectively, first and second common voltages which have high and low levels alternately per frame (per vertical period). Additionally, a level between the first and second common voltages may be inverse.

First and second data voltages are applied to the first and second data lines according to the first and second common voltages. In other words, the first and second data voltages applied to the first and second thin film transistors T1 and T2, respectively, have inverse levels to the first common voltage, and the first and second data voltages applied to the third and fourth thin film transistors T3 and T4, respectively, have inverse levels to the second common voltage.

In each of the pixel regions P1 to P4, the common electrode 120 and the pixel electrode 138 is disposed.

Regions between the common electrode 120 and the pixel electrode 138 have substantially circular band shapes by the common electrode 120 and the pixel electrode 138.

The common electrode 120 includes a first common electrode pattern 120a disposed in the outer portion of the pixel region P and a second common electrode pattern 120b inside the first common electrode pattern 120a. The first and second common electrode patterns 120a and 120b are shaped like a substantially circular band and extend from each of the common lines CL1 and CL2. More particularly, outer side of the first common electrode pattern 120a extends toward the data lines DL1 and DL2 and the gate lines GL1 to GL3, i.e., toward a periphery of each pixel region P1 to P4, and inner side of the first common electrode pattern 120a has a substantially circular line shape.

The pixel electrode 138 includes first and second pixel electrode patterns 138a and 138b. The first pixel electrode pattern 138a having a substantially circular band shape is disposed between the first and second common electrode patterns 120a and 120b, and the second pixel electrode pattern 138b having a substantially circular shape is disposed inside the substantially circular band-shaped second common electrode pattern 120b.

A capacitor electrode 140 spaced apart from the first pixel electrode pattern 138a is disposed in the first common electrode pattern 120a such that the capacitor electrode 140 overlaps the first common electrode pattern 120a and constitutes a storage capacitor with the overlapped portions of the first common electrode pattern 120a. The capacitor electrode 140 includes a first capacitor electrode pattern 140a and a second capacitor electrode pattern 140b. Positions of the first and second capacitor electrode patterns 140a and 140b in the pixel regions P1 to P4 depend on positions of the thin film transistors T1 to T4 in the pixel regions P1 to P4. In other words, the first and second capacitor electrode patterns 140a and 140b are disposed, respectively, in bottom and top portions of the first and third pixel regions P1 and P3, and the first and second capacitor electrode patterns 140a and 140b are disposed, respectively, in top and bottom portions of the second and fourth pixel regions P2 and P4.

The pixel connection line 141 is formed parallel to the data line 128 in the middle of the pixel region P and connects the first and second capacitor electrode patterns 140a and 140b. Furthermore, the pixel connection line 141 also connects the first pixel electrode pattern 138a to the second pixel electrode pattern 138b. Accordingly, the pixel electrode 138, the capacitor electrode 140 and the pixel connection line 141 may be formed as one body in the same patterning process.

In the IPS-LCD device of the first embodiment of the present invention, because alignment directions of liquid crystal molecules are equal with respect to the viewing angles, color shifting is reduced, and thus the viewing angle increases.

To increase aperture ratio, a region between the common electrode and the pixel electrode needs to increase. To do this, a liquid crystal voltage operating the liquid crystal needs to increase.

A second embodiment relates to a driving method of the IPS-LCD device of FIG. 6 to increase aperture ratio and to reduce power consumption.

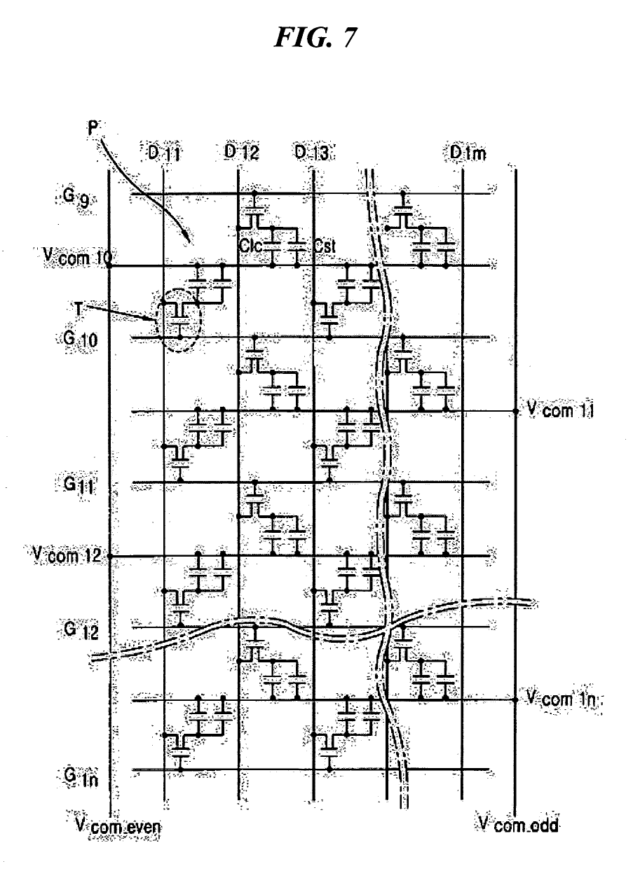

FIG. 7 is an equivalent circuit view of an IPS-LCD device according to a second embodiment of the present invention.

As illustrated in FIG. 7, a plurality of pixels P in an active region (a display region) are arranged in a matrix pattern, a plurality of gate lines G9 to Gln extending along row lines, and a plurality of data lines D11 and D1m extending along column lines are connected with the plurality of pixels P. Each pixel P includes a thin film transistor T connected with the gate and data lines, and a liquid crystal capacitor Clc and a storage capacitor Cst connected with the thin film transistor T. A liquid crystal voltage applied to the liquid crystal capacitor Clc operates a liquid crystal. In the liquid crystal capacitor Clc, a first liquid crystal electrode is a pixel electrode (138 in FIG. 6), and a second liquid crystal electrode is a common electrode (120 in FIG. 6). The storage capacitor Cst prevents falling of the liquid crystal voltage applied to the liquid crystal capacitor Clc. In the storage capacitor Cst, a first storage capacitor electrode is a capacitor electrode (140 in FIG. 6), and a second storage capacitor electrode is the common electrode (120 in FIG. 6) overlapping the capacitor electrode (140 in FIG. 6).

A plurality of common lines Vcom10 to Vcomln are disposed between adjacent gate lines G9 and Gln and extend along the row lines. The common lines Vcom10 to Vcomln include first common lines (even common lines) Vcom10 and Vcom12 connected with the pixels P on the even row lines, and second common lines (odd common lines) Vcom11 and Vcomln connected with the pixels P on the odd row lines. Accordingly, the liquid crystal capacitor Clc and the storage capacitor Cst in each of the pixels P on the even row lines are connected with each of the first common lines Vcom10 and Vcom12, and the liquid crystal capacitor Clc and the storage capacitor Cst in each of the pixels P on the odd row lines are connected with each of the second common lines Vcom11 and Vcomln.

The first common lines Vcom10 and Vcom12 are connected with a first common connection line Vcom_even, and the second common lines Vcom11 and Vcom1n are connected with a second common connection line Vcom_odd. The first and second common connection lines Vcom_even and Vcom_odd are disposed at both sides of the active region.

The first common connection line Vcom_even applies a first common voltage to the first common lines Vcom10 and Vcom12, and the second common connection line Vcom_odd applies a second common voltage to the second common lines Vcom11 and Vcomln. A level of the first common voltage is inverted per frame, and a level of the second common voltage is inverted per frame. Additionally, a level between first and second common voltages may be inverse.

A data voltage applied to each of the data lines D11 to D1m swings between high and low levels alternately per horizontal period depending on the first and second common voltages. In other words, when the first and second common voltages have high and low levels, respectively, the pixels connected with the first common lines Vcom10 and Vcom12 are applied with the data voltages having low levels, and the pixels connected with the second common lines Vcom11 and Vcomln are applied with the data voltages having high levels. Accordingly, because the first common lines Vcom10 and Vcom12 and the second common lines Vcom11 and Vcomln are disposed alternately, the data voltage applied to each of the data lines D11 and D1m swings between high and low levels alternately per horizontal period.

Additionally, because the pixels connected with the turn-on gate line are connected alternately to the first and second common lines, the data voltages applied to adjacent data lines have inverse levels to each other in the turn-on timings of the turn-on gate line.

Therefore, when the first and second common voltages have inverse levels to each other, the pixels on the even row lines, i.e., connected with the first common lines Vcom10 and Vcom12, and the pixels on the odd row lines, i.e., connected with the second common lines Vcom11 and Vcomln have inverse polarities to each other. In other words, the FPS-LCD device is driven in a line-inversion method that the pixels on the same row line have the same polarity and a polarity of the pixels is inverted per row line.

In the IPS-LCD device of the second embodiment of the present invention, because a level of the common voltage is inverted each frame, the swing width of the data voltage can be reduced. In other words, when the common voltage has a low level in a first frame, the data voltage has a high level less than that in the related art so that a liquid crystal voltage has the same positive polar voltage as that in the related art. When the common voltage has a high level in a second frame next to the first frame, the data voltage has a low level, less than that in the related art, in order for the liquid crystal voltage to have the same negative polar voltage as that in the related art. Accordingly, even when the liquid crystal voltage in the present invention has the same polar voltage as that in the related art, the swing width of the data voltage is smaller than that in the related art. Therefore, power consumption to drive the IPS-LCD device in the inversion method can be reduced, and integrated circuit (IC) to output higher power needs not.

Additionally, because swing width of the data voltage is smaller than that in the related art, higher data voltage is applied even when a distance between the common and pixel electrodes increases. Therefore, aperture ratio of the IPS-LCD device can increase.

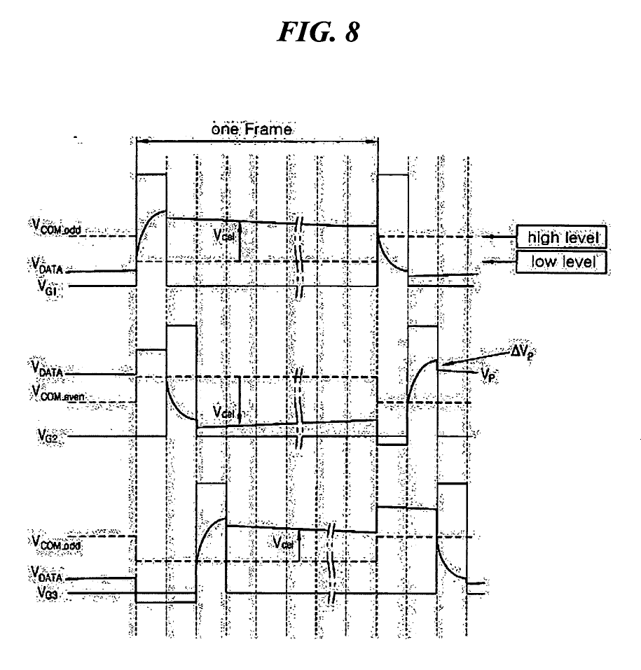

FIG. 8 is a waveform view of driving voltages of a line-inversion method for an IPS-LCD device according to the second embodiment of the present invention.

As illustrated in FIG. 8, first and second common voltages Vcom_even and Vcom_odd have alternately a high level and a low level per frame.

Gate voltages V_{G1} to V_{G3} are applied sequentially to gate lines. Data voltage V_{DATA} has a high level and a low level alternately depending upon the common voltages Vcom_even and Vcom_odd. In other words, when the common voltages Vcom_even and Vcom_odd have high levels, the data voltage V_{DATA} has a low level lower than high levels of the common voltage Vcom_even and Vcom_odd. When the common voltages Vcom_even and Vcom_odd have low levels, the data voltage V_{DATA} has a high level higher than low levels of the common voltages Vcom_even and Vcom_odd. The data voltage V_{DATA} has high and low levels alternately depending upon sequential turn-on timing of the gate voltages VG1 to VG3.

When the gate voltage V_{G} is in an on-state, i.e., high level, a thin film transistor (T in FIG. 7) turns on, and thus the data voltage V_{DATA} is applied to a liquid crystal capacitor (Clc in FIG. 7) to produce a pixel voltage Vp.

When the gate voltage V_{G} is in an off-state, i.e., low level, a thin film transistor (T in FIG. 7) turns off, and thus the data voltage V_{DATA} is not applied to a liquid crystal capacitor (Clc in FIG. 7). Because the gate electrode and the drain electrode of the thin film transistor (T in FIG. 7) overlap each other, the parasitic capacitance therebetween occurs. Accordingly, the pixel voltage Vp falls by ΔVp when the thin film transistor (T in FIG. 7) turns off.

A liquid crystal voltage Vcel of the liquid crystal capacitor (Clc in FIG. 7) operates a liquid crystal, and that is got by Vp-Vcom.

Because the common voltage and the data voltage have inverse levels with respect to each other, the liquid crystal voltage can have a higher voltage than that in the related art. For example, when maximum output voltage of integrated circuit (IC) is 10V, the liquid crystal voltage can have a maximum voltage of 10V because the common voltage swings. Accordingly, the liquid crystal voltage can have a higher voltage than that in the related art.

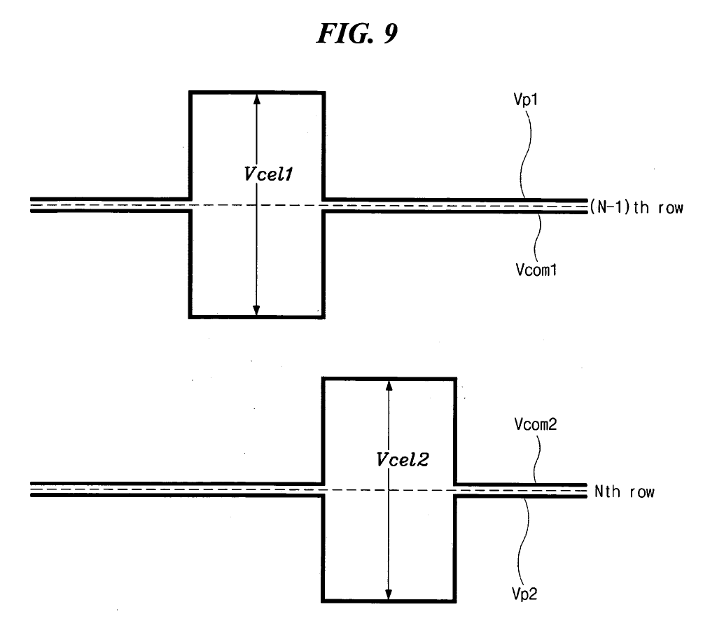

FIG. 9 is a waveform view of pixel voltages and common voltages applied to adjacent pixels, which are on the same column line, of an IPS-LCD device according to the second embodiment of the present invention.

As illustrated in FIG. 9, a first pixel on a (N-1)ₜₕ row line is applied with a first pixel voltage Vp1 and a first common voltage Vcom1, and a second pixel on a Nₜₕ row line is applied with a second pixel voltage Vp2 and a second common voltage Vcom2. The first pixel voltage Vp1 and the second pixel voltage Vp2 are applied sequentially, and have a high level and a low level, respectively. As the first pixel voltage Vp1 has a high level, the first common voltage Vcom1 has a low level, and thus a first liquid crystal voltage Vcel1 has a positive polar voltage. As the second pixel voltage Vp2 has a low level, the second common voltage Vcom2 has a high level, and thus a second liquid crystal voltage Vcel2 has a negative polar voltage. As such, a level between the common voltages applied to adjacent pixels on the same column line is inverted, a level between the data voltages applied to adjacent pixels on the same column line is inverted depending upon a level of the common voltage, and thus the IPS-LCD device is driven in the inversion method.

In the present invention, the common electrode and the pixel electrode have substantially circular band shapes. Therefore, color shifting is reduced, and thus the viewing angle increases. Additionally, the common voltage swings alternately between high and low levels, and the data voltage swings alternately between high and low levels depending upon the common voltage. Therefore, power consumption in the inversion method can be reduced, integrated circuit (IC) to output higher power needs not, and aperture ratio can increase.

Meanwhile, in the present invention, the pixel electrode and the common electrode may have an elliptical band shape.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
first and second gate lines in an active region, and first and second data lines crossing the first and second gate lines, respectively, wherein the first and second gate lines, and the first and second data lines define first and second pixel regions;
first and second thin film transistors in the first and second pixel regions, wherein the first thin film transistor connected with the first data line and the second gate line, and the second thin film transistor connected with the second data line and the first gate line;
first and second pixel electrodes connected with the first and second thin film transistors;
first and second common electrodes defining first and second substantially circular band shaped regions with the first and second pixel electrodes; and
a first common line connected with the first and second common electrodes.

2. The device according to claim 1, wherein each of the first and second common electrodes includes first and second common electrode patterns, and each of the first and second pixel electrodes includes first and second pixel electrode patterns, wherein the first pixel electrode pattern is disposed between the first and second common electrode patterns, and the second pixel electrode pattern is disposed inside the second common electrode pattern.

3. The device according to claim 2, wherein an outer side of the first common electrode pattern extends toward a periphery of each of the first and second pixel regions; an inner side of the first common electrode pattern has a substantially circular line shape; the second common electrode pattern has a substantially circular band shape, the first pixel electrode pattern has a substantially circular band shape, and the second pixel electrode pattern has a substantially circular shape.

4. The device according to claim 2, further comprising a capacitor electrode disposed in each of the first and second pixel regions and overlapping the first common electrode pattern.

5. The device according to claim 4, the capacitor electrode includes a first capacitor electrode pattern connecting each of the first and second thin film transistors and each of the first and second pixel electrodes, and a second capacitor electrode pattern connected with each of the first and second pixel electrodes.

6. The device according to claim 4, further comprising a pixel connection line connecting the capacitor electrode and each of the first and second pixel electrodes.

7. The device according to claim 1, wherein the first and second common electrodes define first and second elliptical band shaped regions with the first and second pixel electrodes, respectively.

8. The device according to claim 1, further comprising:
a third gate line, wherein the second and third gate lines, and the first and second data lines define third and fourth pixel regions;
third and fourth thin film transistors in the third and fourth pixel regions, wherein the third thin film transistor connected with the first data line and the third gate line, and the fourth thin film transistor connected with the second data line and the second gate line;
third and fourth pixel electrodes connected with the third and fourth thin film transistors;
third and fourth common electrodes defining third and fourth substantially circular band shaped regions with the third and fourth pixel electrodes; and
a second common line connected with the third and fourth common electrodes.

9. The device according to claim 8, wherein each of the third and fourth common electrodes includes first and second common electrode patterns, and each of the third and fourth pixel electrodes includes first and second pixel electrode patterns, wherein the first pixel electrode pattern is disposed between the first and second common electrode patterns, and the second pixel electrode pattern is disposed inside the second common electrode pattern.

10. The device according to claim 9, wherein an outer side of the first common electrode pattern extends toward a periphery of each of the third and fourth pixel regions; an inner side of the first common electrode pattern has a substantially circular line shape; the second common electrode pattern has a substantially circular band shape; the first pixel electrode pattern has a substantially circular band shape; and the second pixel electrode pattern has a substantially circular shape.

11. The device according to claim 8, wherein the third and fourth common electrodes define first and second elliptical band shaped regions with the third and fourth pixel electrodes.

12. The device according to claim 8, further comprising first and second common connection lines connected with first and second common lines, wherein the first and second common connection lines are disposed at both sides of the active region.

13. A liquid crystal display device, comprising:
first and second gate lines in an active region, and first and second data lines crossing the first and second gate lines, respectively;
a first pixel connected with the first data line and the second gate line, and a second pixel connected with the second data line and the first gate line;
a first thin film transistor and a first liquid crystal capacitor in the first pixel;
a second thin film transistor and a second liquid crystal capacitor in the second pixel, wherein the first and second liquid crystal capacitors are connected with the first and second thin film transistors; and
a first common line connected with the first and second liquid crystal capacitors.

14. The device according to claim 13, wherein each of the first and second liquid crystal capacitors includes a common electrode and a pixel electrode, wherein the common electrode and the pixel electrodes define substantially circular band shaped regions.

15. The device according to claim 13, further comprising first and second storage capacitors connected in parallel with the first and second liquid crystal capacitors.

16. The device according to claim 13, further comprising:
a third gate line;
a third pixel connected with the first data line and the third gate line, and a fourth pixel connected with the second data line and the second gate line;
a third thin film transistor and a third liquid crystal capacitor in the third pixel, and a fourth thin film transistor and a fourth liquid crystal capacitor in the fourth pixel, wherein the third and fourth liquid crystal capacitors are connected with the third and fourth thin film transistors; and
a second common line connected with the third and fourth liquid crystal capacitors.

17. The device according to claim 16, wherein each of the third and fourth liquid crystal capacitors includes a common electrode and a pixel electrode, wherein the common electrode and the pixel electrodes define substantially circular band shaped regions.

18. The device according to claim 16, further comprising first and second storage capacitors connected in parallel with the third and fourth liquid crystal capacitors.

19. The device according to claim 13, further comprising first and second common connection lines connected with first and second common lines, wherein the first and second common connection lines are disposed at both sides of the active region.

20. A driving method of a liquid crystal display device, comprising:
scanning first, second and third gate lines sequentially;
applying first and second data voltages to first and second data lines;
applying a first common voltage to a first pixel connected with the second gate line and the first data line, and to a second pixel connected with the first gate line and the second data line, wherein the first common voltage have high and low levels alternately per frame; and
applying a second common voltage to a third pixel connected with the third gate line and the first data line, and to a fourth pixel connected with the second gate line and the second data line, wherein the second common voltage have high and low levels alternately per frame,
wherein the first data voltage applied to the first pixel has a inverse level to the first common voltage, the second data voltage applied to the second pixel has a inverse level to the first common voltage, the first data voltage applied to the third pixel has a inverse level to the second common voltage, and the second data voltage applied to the fourth pixel has a inverse level to the second common voltage.

21. The method according to claim 20, wherein the first pixel has the same polarity as the second pixel, the third pixel has the same polarity as the fourth pixel, and a voltage polarity between the first and third pixels is inverted.

22. The method according to claim 20, wherein a voltage level between the first and second common voltages is inverted.

23. The method according to claim 22, wherein a voltage level between the first and second data voltages is inverted when each of the first to third gate lines turns on.

24. The device according to claim 20, wherein each of the first to fourth pixels includes a common electrode and a pixel electrode, wherein the common electrode and the pixel electrodes define substantially circular band shaped regions.
